(19) United States
(12) Patent Application Publication
(10) Pub. No.: US 2009/0002158 A1
(43) Pub. Date: Jan. 1, 2009

(54) Look down lens as light diffuser in a passive infrared intrusion detection device

(75) Inventor: Mark Alan Striver, Folsom, CA (US)

Correspondence Address: DLA PIPER US LLP, 2000 UNIVERSITY AVENUE, E. PALO ALTO, CA, 94303-2248, US

(73) Assignee: ALEPH AMERICA

(21) Appl. No.: 11/824,401

(22) Filed: Jun. 28, 2007

(51) Int. Cl. G08B 13/18

(52) U.S. Cl. 340/567

(57) ABSTRACT

A passive infrared intrusion detection device has a housing with an infrared sensor in the housing. A focusing element is mounted in the housing for focusing infrared radiation from an area through the housing to the infrared sensor. A visible radiation emission device is in the housing, with the radiation emission device positioned to radiate visible spectrum radiation through the focusing element out of the housing.

### TECHNICAL FIELD

The present invention relates to an intrusion detection device having a housing, a passive infrared sensor, a focusing element to focus infrared radiation from an area onto the passive infrared sensor, and a visible radiation emission device, all in the housing. More particularly, in the present invention, the visible radiation emission device is positioned to radiate the visible radiation through the focusing element.

### BACKGROUND OF THE INVENTION

Intrusion detection devices are well known. One example of an intrusion detection device is the use of passive infrared detection device to detect human intruders who emit infrared radiation in certain fields. See for example, U.S. Pat. No. 6,559,448. Typically a prior art passive intrusions detection device 10, shown in FIG. 1, comprises a housing 12. The housing 12 contains a passive infrared detection sensor 14, typically mounted along the rear wall of the housing 12. A first focusing element 16, such as a Fresnel lens 16 is mounted in or along the front wall of the housing 12. The Fresnel lens 16 focuses infrared radiation from a far field that the passive infrared detection device 10 is directed to protect. The device 10 also comprises a look down lens 22. The look down lens 22 is positioned to focus infrared radiation from a near field, i.e. closer to the device 10 than the far field that is focused by the element 16. Infrared radiation gathered by the Fresnel lens 16 and the look down lens 22 are focused onto the infrared sensor 14. Typically, the prior art device 10 also comprises an LED 18, which emits visible radiation. The LED 18 emits visible radiation indicating the status of the device 10, with the visible radiation passing through a diffuser 20, which is also mounted on or along the front wall of the housing 12.

Since the device 10 is typically a consumer product, there is a desire to keep the manufacturing cost down. Thus, the use of a diffuser as a separate element is costly.

### SUMMARY OF THE INVENTION

A passive infrared intrusion detection device comprises a housing. An infrared sensor is in the housing. A focusing element is mounted in the housing for focusing infrared radiation from an area through the housing to the infrared sensor. A visible radiation emission device is in the housing. The radiation emission device is positioned to radiate visible spectrum radiation through the focusing element out of the housing.

### BRIEF DESCRIPTION OF THE DRAWINGS

FIG. 1 is a schematic side view of an intrusion detection device of the prior art.

FIG. 2 is a schematic side view of an intrusion detection device of the present invention.

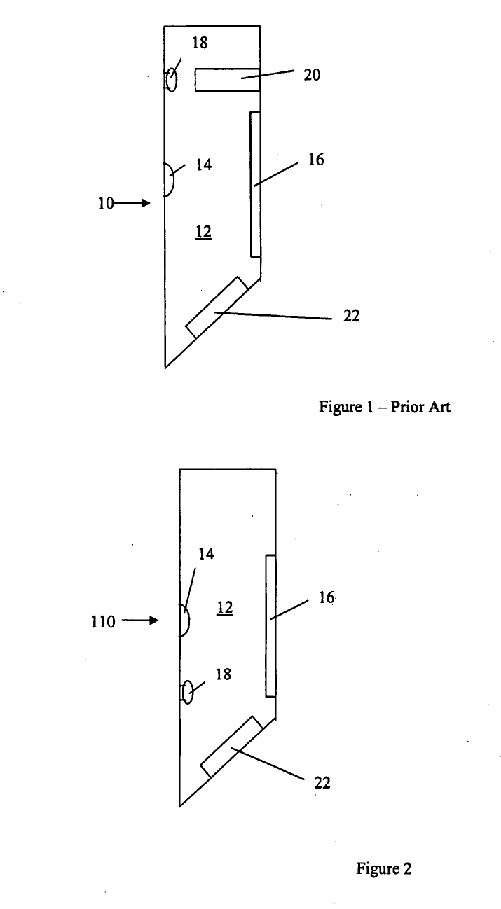

### DETAILED DESCRIPTION OF THE INVENTION

Referring to FIG. 2 there is shown a schematic block diagram of an intrusion detection device 110 of the present invention. The device 110 is similar to the device 10 of the prior art. Hence like parts will be designated with the same numeral. The device 10 comprises a housing 12. The housing 12 contains a passive infrared detection sensor 14, typically mounted along the rear wall of the housing 12. A first focusing element 16, such as a Fresnel lens 16 is mounted in or along the front wall of the housing 12. The Fresnel lens 16 focuses infrared radiation from a far field that the passive infrared detection device 110 is directed to protect. The device 110 also comprises a look down lens 22. The look down lens 22 is positioned to focus infrared radiation from a near field, i.e. closer to the device 110 than the far field that is focused by the element 16. Infrared radiation gathered by the Fresnel lens 16 and the look down lens 22 are focused onto the infrared sensor 14. The device 110 also comprises an LED 18, which emits visible radiation. The LED 18 emits visible radiation indicating the status of the device 110. The LED 18 is positioned such that the visible radiation passes through the look down lens 22. Because the look down lens 22 is also a diffuser, the light form the LED 18 is automatically diffused after passing through the look down lens 22.

From the foregoing it can be seen that by using the look down lens 22 both as a lens to focus the infrared radiation from the near field to focus onto the infrared sensor 14, as well as to permit visible radiation from the LED 18 to be emitted from within the housing 110 to the external, the look down lens 22 serves a dual purpose, thereby making the device 110 more compact and less costly to manufacture.

What is claimed is:

1. A passive infrared intrusion detection device comprising::
a housing;
an infrared sensor in the housing;
a focusing element mounted in the housing for focusing infrared radiation from an area through the housing to the infrared sensor; and
a visible radiation emission device in the housing, said radiation emission device is positioned to radiate visible spectrum radiation through the focusing element out of the housing.

2. The passive infrared intrusion detection device of claim 1 wherein said focusing element comprises:
a plurality of sub-elements; and
wherein said radiation emission device is positioned to radiate visible radiation through one of the sub-elements.

3. The passive infrared intrusion detection device of claim 2 wherein said one sub-element is a diffuser.

4. The passive infrared intrusion detection device of claim 3 wherein said one sub-element is a look down sub-element.

5. The passive infrared intrusion detection device of claim 4 wherein said radiation emission device is an LED.

6. The passive infrared intrusion detection device of claim 5 wherein said LED is a status indicator.
